(19) United States
(12) Patent Application Publication
(10) Pub. No.: US 2010/0124078 A1
(43) Pub. Date: May 20, 2010

(54) ELECTRONIC DEVICE AND POWER SUPPLY THEREOF

(75) Inventor: JIAN-HUI LU, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/620,610

(22) Filed: Nov. 18, 2009

(30) Foreign Application Priority Data
Nov. 19, 2008 (CN) 200810305638.0

(51) Int. Cl. H02M 3/335; H02M 3/22

(52) U.S. Cl. 363/21.01; 363/15

(57) ABSTRACT

A power supply includes a first convertor, a second convertor, and a transformer. The first convertor generates an alternating current (AC) voltage. The transformer includes a primary winding and a secondary winding. The primary winding is connected to the first convertor and receives the AC voltage. The secondary winding includes a first tap, a second tap, and a third tap disposed between the first tap and the second tap. The second convertor includes a first rectifier circuit connected to the first tap and the second tap, and a second rectifier circuit connected to the third tap. The first rectifier circuit generates a first direct current (DC) voltage. The second rectifier circuit generates a second DC voltage.

### BACKGROUND

1. Technical Field

Embodiments of the present disclosure relate to power supplies, and particularly to a power supply of an electronic device.

2. Description of Related Art

Power supplies, having multiple outputs, usually adopts a tapped transformer and a convertor to convert a voltage from the mains/wall power to two or more lower direct current (DC) voltages. The two or more DC voltages are used to power different operation modules of an electronic device, such as a television, a desktop computer, a notebook computer, a projector, etc. Most current transformers need five taps (as used here, a tap refers to any connection to the secondary coil of the transformer) for two outputs. This tap to output ratio complicates the design of the power supply, has poor utilization of the transformer winding, and produces an excessive amount of electro-magnetic interferences (EMI).

Therefore, an improved power supply for an electronic device is needed to address the aforementioned deficiency and inadequacies.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram showing an electronic device including a power supply in accordance with an embodiment of the present disclosure.

FIG. 2 is a circuit diagram showing the power supply of FIG. 1.

### DETAILED DESCRIPTION

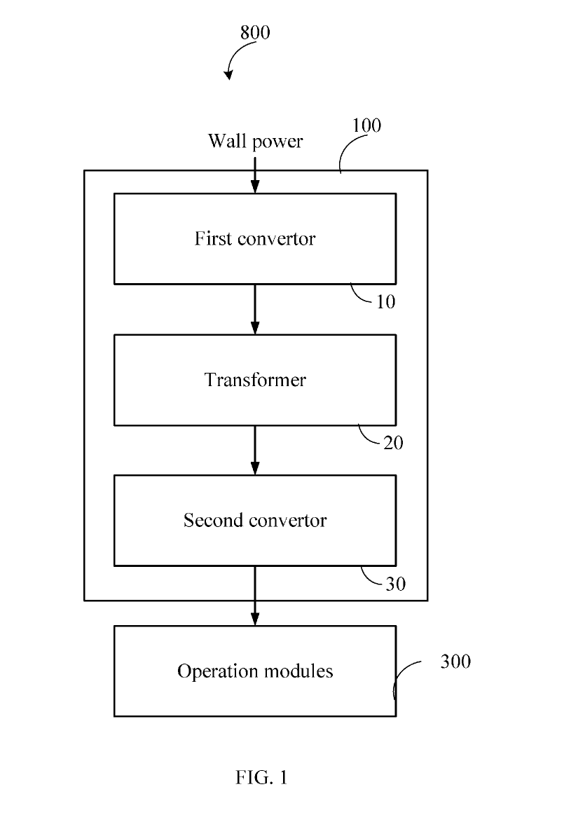

Referring to FIG. 1, an electronic device 800 in accordance with an exemplary embodiment includes a power supply 100 and a plurality of operation modules 300. The electronic device 800 may be a desktop computer, a television, a projector, a media player, etc. The plurality of operation modules 300 may include a display, an input device, an audio output module, a data processing unit, etc. The power supply 100 is configured for supplying the appropriate direct current (DC) voltages to the plurality of operation modules 300. In the embodiment, the power supply 100 is a switched mode power supply (SMPS).

The power supply 100 includes a first convertor 10, a second convertor 30, and a transformer 20 electrically connected between the first and second convertors 10, 30. The power supply 100 is capable of utilizing three taps of the transformer winding to supply two outputs, thus producing less electro-magnetic interferences (EMI).

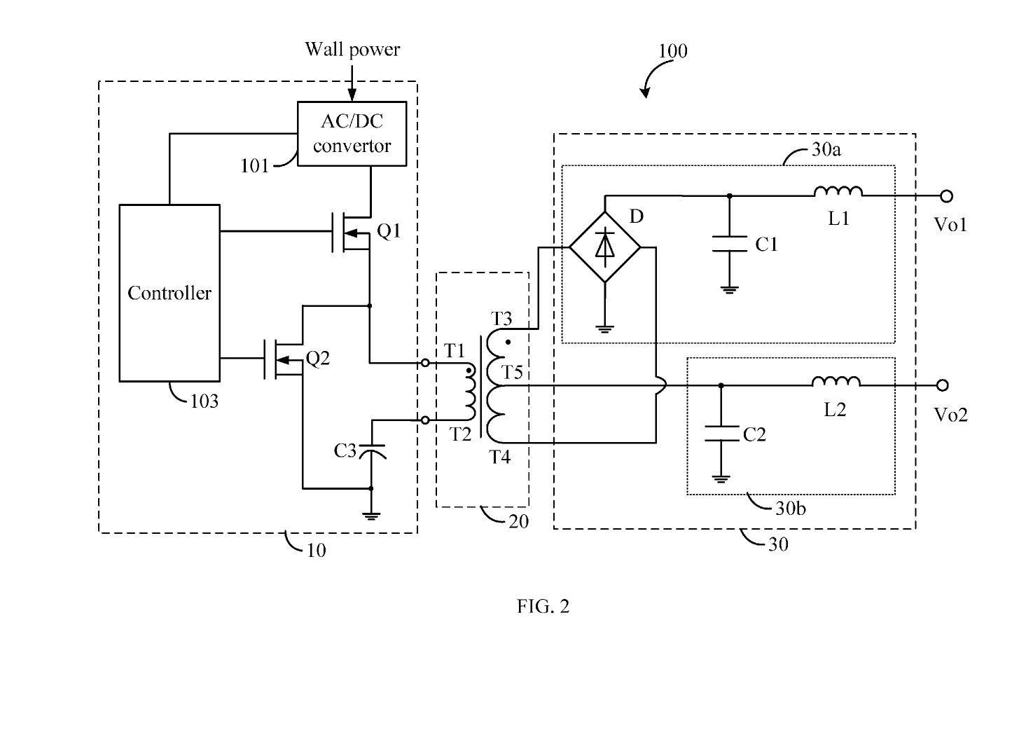

Referring to FIG. 2, the first convertor 10 is configured for supplying an alternating current (AC) voltage. The transformer 20 generates an inducted voltage based on the AC voltage. The transformer 20 includes a primary winding and a secondary winding. The primary winding is connected to the first convertor 10 via two terminals T1, T2, and receives the AC voltage. The secondary winding includes a first tap T3, a second tap T4, and a third tap T5 disposed between the first tap T3 and the second tap T4. The third tap T5 is the center tap of the secondary winding.

In the embodiment, the first convertor 10 includes an AC/DC convertor 101, a controller 103, a first switch component Q1, a second switch component Q2, and a third capacitor C3. The AC/DC convertor receives an AC voltage from the wall power via a plug (not shown), and converts the AC voltage into a third DC voltage and a fourth DC voltage. The third DC voltage is supplied to the first switch component Q1, and the fourth DC voltage is supplied to and powers the controller 103.

The controller 103 is configured to alternately turn on and turn off the first switch component Q1 and second switch component Q2. When the first switch component Q1 is turned on, the second switch component Q2 is turned off.

The first switch component Q1 receives the third DC voltage and transmits it to the primary winding of the transformer 20 to charge the third capacitor C3 when the first switch component Q1 is turned on. The second switch component Q2 grounds the primary winding of the transformer 20 when the second switch component Q2 is turned on, and the third capacitor C3 discharges via the primary winding and the second switch component Q2. In the embodiment, the first switch component Q1 and the second switch component Q2 are both metal-oxide semiconductor field-effect transistors (MOSFET). The drain of the first switch component Q1 receives the third DC voltage, the gate of the first switch component Q1 is connected to the controller 103, and the source of the first switch component Q1 is connected to the terminal T1 of the primary winding and the drain of the second switch component Q2. The gate of the second switch component Q2 is connected to the controller 103, and the source of the second switch component Q2 is grounded. In other embodiments, the first switch component Q1 and the second switch component Q2 may be bipolar junction transistors (BJT).

The second convertor 30 includes a first rectifier circuit 30a and a second rectifier circuit 30b. The first rectifier circuit 30a is connected to the first tap T3 and the second tap T4, converts the induced voltage into a first DC voltage, and outputs the first DC voltage via a first output terminal Vo1. The second rectifier circuit 30b is connected to the third tap T5, converts a half of the induced voltage into a second DC voltage, and outputs the second DC voltage via a second output terminal Vo2. Understandably, because of the center tap, the first DC voltage is double the second DC voltage.

In the embodiment, the first rectifier circuit 30a includes a diode bridge D, a first capacitor C1, and a first inductor L1. The diode bridge D includes two input terminals connected to the first and second taps T3, T4 of the secondary winding of the transformer 20, a ground terminal, and an output terminal connected to a terminal of the first capacitor C1 and a first terminal of the first inductor L1. The other terminal of the first capacitor C2 is grounded. A second terminal of the first inductor L1 is connected to the first output terminal Vo1. The second rectifier circuit 30b includes a second capacitor C2 and a second inductor L2. The second capacitor C2 includes a first terminal connected to the third tap T5 of the transformer 20, and a second terminal connected to ground. The second inductor L2 includes a first terminal connected to the third tap T5, and a second terminal connected to the second output terminal Vo2.

To summarize, the power supply 100 utilizes three taps of the transformer 20 to generate two different DC voltages. The structure of the circuit of the power supply 100 is simpler, and produces less EMI. Furthermore, the transformer can use a wide secondary winding, thus reducing power loss.

In other embodiments, when two more DC voltage is needed, another secondary winding similar to the above-described secondary winding and another convertor similar to the second convertor 30 can be utilized. When only one more DC voltage is needed, another secondary winding including two outer taps and a rectifier circuit similar to the first rectifier circuit 30a can be utilized.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A power supply, comprising:
a first convertor for supplying a primary alternating current (AC) voltage;
a transformer comprising a primary winding and a secondary winding, the primary winding connected to the first convertor and receiving the primary AC voltage, the transformer transforming the primary AC voltage to a secondary AC voltage in the secondary winding, the secondary winding comprising a first tap, a second tap, and a third tap disposed between the first tap and the second tap; and
a second convertor comprising a first rectifier circuit connected to the first tap and the second tap, and a second rectifier circuit connected to the third tap, the first rectifier circuit outputting a first direct current (DC) voltage based on the secondary AC voltage, the second rectifier circuit outputting a second DC voltage based on the secondary AC voltage.

2. The power supply of claim 1, wherein the second DC voltage is lower than the first DC voltage.

3. The power supply of claim 1, wherein the first rectifier circuit comprises a diode bridge and a first capacitor, the diode bridge comprises two input terminals connected to the first and second taps of the secondary winding, a ground terminal, and an output terminal connected to a terminal of the first capacitor, the other terminal of the first capacitor is grounded.

4. The power supply of claim 3, wherein the first rectifier circuit further comprises a first inductor, the first inductor comprises a first terminal connected to the output terminal of the diode bridge, and a second terminal connected to a first output terminal of the power supply.

5. The power supply of claim 1, wherein the second rectifier circuit comprises a second capacitor comprising a first terminal connected to the third tap of the transformer, and a second terminal connected to ground.

6. The power supply of claim 5, wherein the second rectifier circuit further comprises a second inductor, the second inductor comprises a first terminal connected to the third tap, and a second terminal connected to a second output terminal of the power supply.

7. The power supply of claim 1, wherein the first convertor comprises a controller, a first switch component, a second switch component, and a third capacitor; the controller alternately turns on and turns off the first switch component and the second switch component, when the first switch component is turned on, the second switch component is turned off; the first switch component receives a third DC voltage and transmits it to a first terminal of the primary winding when turned on; the second switch component grounds the first terminal of the primary winding when turned on; a first terminal of the third capacitor is connected to a second terminal of the primary winding, and a second terminal of the third capacitor is grounded.

8. The power supply of claim 7, wherein the first convertor further comprises an AC/DC convertor for converting an AC voltage from the wall power into the third DC voltage.

9. The power supply of claim 8, wherein the AC/DC convertor further generates a fourth DC voltage for powering the controller.

10. The power supply of claim 7, wherein the first switch component and the second switch component are metal-oxide semiconductor field-effect transistor.

11. A power supply, comprising:
a transformer comprising a primary winding and a secondary winding, the primary winding receiving an alternating current (AC) voltage, the secondary winding comprising a first tap, a second tap, and a third tap disposed between the first tap and the second tap; and
a second convertor comprising a first rectifier circuit connected to the first tap and the second tap, and a second rectifier circuit connected to the third tap, the first rectifier circuit outputting a first direct current (DC) voltage, the second rectifier circuit outputting a second DC voltage.

12. The power supply of claim 11, wherein the second DC voltage is half the value of the first DC voltage.

13. The power supply of claim 11, wherein the first rectifier circuit comprises a diode bridge, a first capacitor, and a first inductor, the diode bridge comprises two input terminals connected to the first and second taps of the transformer, a ground terminal, and an output terminal connected to a terminal of the first capacitor and a first terminal of the first inductor, the other terminal of the first capacitor is grounded, a second terminal of the first inductor is connected to a first output terminal of the power supply.

14. The power supply of claim 11, wherein the second rectifier circuit comprises a second capacitor and a second inductor, the first capacitor comprises a first terminal connected to the third tap of the transformer, and a second terminal connected to ground, the second inductor comprises a first terminal connected to the third tap, and a second terminal connected to a second output terminal of the power supply.

15. An electronic device, comprising:
a plurality of operation modules;
a first convertor for supplying an alternating current (AC) voltage;
a transformer comprising a primary winding and a secondary winding, the primary winding connected to the first convertor and receiving the AC voltage, the secondary winding comprising a first tap, a second tap, and a third tap disposed between the first tap and the second tap; and
a second convertor comprising a first rectifier circuit connected to the first tap and the second tap, and a second rectifier circuit connected to the third tap, the first rectifier circuit outputting a first direct current (DC) voltage to power at least one of the a plurality of loads, the second rectifier circuit outputting a second DC voltage to power at least one of the a plurality of loads.

16. The electronic device of claim 15, wherein the second DC voltage is lower than the first DC voltage.

17. The electronic device of claim 15, wherein the first rectifier circuit comprises a diode bridge, a first capacitor, and a first inductor, the diode bridge comprises two input terminals connected to the first and second taps of the transformer, a ground terminal, and an output terminal connected to a terminal of the first capacitor and a first terminal of the first inductor, the other terminal of the first capacitor is grounded, a second terminal of the first inductor is connected to the at least one of the a plurality of loads.

18. The electronic device of claim 15, wherein the second rectifier circuit comprises a second capacitor and a second inductor, the first capacitor comprises a first terminal connected to the third tap of the transformer, and a second terminal connected to ground, the second inductor comprises a first terminal connected to the third tap, and a second terminal connected to the at least one of the a plurality of loads.

19. The electronic device of claim 15, wherein the first convertor comprises a controller, a first switch component, a second switch component, and a third capacitor; the controller alternately turns on and turns off the first switch component and the second switch component, when the first switch component is turned on, the second switch component is turned off; the first switch component receives a third DC voltage and transmits it to a first terminal of the primary winding when turned on; the second switch component grounded the first terminal of the primary winding when turned on; a first terminal of the third capacitor is connected to a second terminal of the primary winding, and a second terminal of the third capacitor is grounded.

20. The electronic device of claim 19, wherein the first convertor further comprises an AC/DC convertor for converting an AC voltage from the wall power into the third DC voltage.
